(19) United States
(12) Patent Application Publication
(10) Pub. No.: US 2013/0158898 A1
(43) Pub. Date: Jun. 20, 2013

(54) MOBILE-OBJECT INFORMATION ACQUIRING APPARATUS, MOBILE-OBJECT INFORMATION ACQUIRING METHOD, MOBILE-OBJECT INFORMATION ACQUIRING PROGRAM, AND RECORDING MEDIUM

(71) Applicants: Tatsuya Fukuda, Saitama (JP); Mitsuo Yasushi, Sayama (JP); Susumu Ohsawa, Sakado (JP); Kyoichiro Fujii, Kawagoe (JP)

(72) Inventors: Tatsuya Fukuda, Saitama (JP); Mitsuo Yasushi, Sayama (JP); Susumu Ohsawa, Sakado (JP); Kyoichiro Fujii, Kawagoe (JP)

(73) Assignee: PIONEER CORPORATION, Kanagawa (JP)

(21) Appl. No.: 13/818,991

(22) PCT Filed: Aug. 31, 2010
(86) PCT No.: PCT/JP2010/064844

§ 371 Date: Feb. 26, 2013

(51) Int. Cl. G06F 17/00

(52) U.S. Cl. CPC G06F 17/00
USPC 702/45

(57) ABSTRACT

A mobile-object information acquiring apparatus (100) acquires the state of a mobile object. A current-information acquiring unit (101) acquires energy consumption (actual energy consumption) accompanying travel of the mobile object. As setting unit (102) sets for each factor causing energy consumption of the mobile object to change, information related to the mobile object affected by the factor. An estimating unit (103), based on information that is related to the mobile object and for a reference point in time, estimates energy consumption (reference energy consumption) consequent to the travel of the mobile object. A calculating unit (104) calculates for each factor, the amount of change of the actual energy consumption with respect to the reference energy consumption.

### TECHNICAL FIELD

The present invention relates to a mobile-object information acquiring apparatus, a mobile-object information acquiring method, a mobile-object information acquiring program, and a recording medium that acquire a state of a mobile object. Nonetheless, application of the present invention is not limited to the mobile-object information acquiring apparatus, the mobile-object information acquiring method, the mobile-object information acquiring program, and the recording medium.

### BACKGROUND ART

Conventionally, vehicular information display apparatuses are known that display on a display unit, information to prompt the user to drive more fuel efficiently (for example, refer to Patent Document 1 below). In Patent Document 1, travel resistance is calculated based on vehicle speed and travel distance, and is displayed on the display unit.

Patent Document 1: Japanese Patent No. 3522035

### DISCLOSURE OF INVENTION

### Problem to be Solved by the Invention

Nonetheless, with the technology described in Patent Document 1, travel resistance for the distance travelled overall is calculated based on the vehicle speed and the distance travelled from a departure point to a destination point. Consequently, the travel resistance that arises under a given travel state at a given point in time cannot be determined between the departure point and the destination point. Therefore, even if the travel resistance changes, since the travel state causing the travel resistance is unknown, a problem arises in that, for example, factors that cause changes in the travel resistance cannot be identified.

### Means for Solving Problem

To solve the problems above and achieve an object, a mobile-object information acquiring apparatus according the invention of claim 1 includes a current-information acquiring unit that acquires energy consumption (hereinafter, “actual energy consumption”) accompanying travel of a mobile object; a setting unit that sets for each factor causing energy consumption of the mobile object to change, information related to the mobile object having the factor; an estimating unit that based on the information related to the mobile object for a reference point in time and set by the setting unit, estimates energy consumption consequent to travel (hereinafter, “reference energy consumption”); and a calculating unit that for each of the factors, calculates an amount of change of the actual energy consumption with respect to the reference energy consumption.

A mobile-object information acquiring apparatus according to the invention of claim 8 includes a current-information acquiring unit that acquires energy consumption (hereinafter, “actual energy consumption”) accompanying travel of a mobile object; an estimating unit that based on the actual energy consumption and for each factor causing energy consumption of the mobile object to change, respectively estimates information related to the mobile object affected by the factor; a recording unit that records the information that is related to the mobile object and estimated by the estimating unit; and a calculating unit that calculates for each factor and with respect to information that is related to the mobile object and recorded by the recording unit at a past given point in time, an amount of change of the information that that is related to the mobile object and estimated by the estimating unit.

A mobile-object information acquiring method according to the invention of claim 9 is a mobile-object information acquiring method of a mobile-object information acquiring apparatus that acquires information of a mobile object. The mobile-object information acquiring method include a current-information acquiring step of acquiring energy consumption (hereinafter, “actual energy consumption”) accompanying travel of the mobile object; an estimating step of separating the actual energy consumption according to factors causing energy consumption of the mobile object to change and estimating actual energy consumption caused by each factor; a reference information acquiring step of acquiring for each factor, energy consumption (hereinafter, “reference energy consumption”) accompanying the travel of the mobile object at a reference point in time; and a calculating step of calculating for each factor, an amount of change of the actual energy consumption with respect to the reference energy consumption.

A mobile-object information acquiring program according to the invention of claim 10 causes a computer to execute the mobile-object information acquiring method recited in claim 9.

A computer-readable recording medium according to the invention of claim 11 stores the mobile-object information acquiring program recited in claim 10.

### BRIEF DESCRIPTION OF DRAWINGS

FIG. 1 is a block diagram of a functional configuration of a mobile-object information acquiring apparatus according to an embodiment;

FIG. 2 is a flowchart of a mobile object information acquiring process by the mobile-object information acquiring apparatus;

FIG. 3 is a block diagram of a hardware configuration of a navigation apparatus;

FIG. 4 is a flowchart of the mobile object information acquiring process by the navigation apparatus;

FIG. 5 is a flowchart the mobile object information acquiring process of by the navigation apparatus;

FIG. 6 is a flowchart of yet another mobile object information acquiring process by the navigation apparatus; and

FIG. 7 is a diagram of one example of a display screen displayed on a display of the navigation apparatus.

### BEST MODE(S) FOR CARRYING OUT THE INVENTION

With reference to the accompanying drawings, preferred embodiments of a mobile-object information acquiring apparatus, a mobile-object information acquiring method, a mobile-object information acquiring program, and a recording medium according to the present invention will be described in detail.

### Embodiment

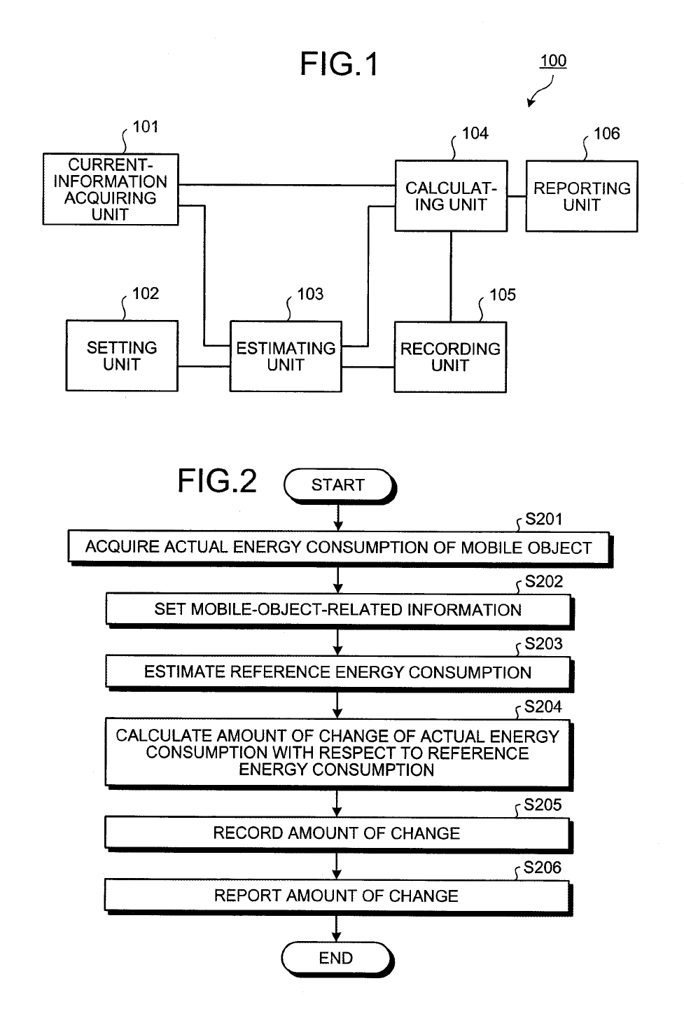

FIG. 1 is a block diagram of a functional configuration of the mobile-object information acquiring apparatus according to an embodiment. A mobile-object information acquiring apparatus 100 according to the embodiment calculates an amount of change for each factor that changes energy consumption of a mobile object, and based on the amount of change, acquires the state of the mobile object. The mobile-object information acquiring apparatus 100 includes a current-information acquiring unit 101, a setting unit 102, an estimating unit 103, a calculating unit 104, a recording unit 105, and a reporting unit 106.

The current-information acquiring unit 101 acquires the amount of energy consumed for travel by the mobile object (hereinafter, “actual energy consumption”). For example, via an in-vehicle communication network operated under a communication protocol such as for a controller area network (CAN), the current-information acquiring unit 101 acquires for each factor that changes the energy consumption of the mobile object, the actual energy consumption, which is managed by an electronic control unit (ECU).

A factor that changes the energy consumption of the mobile object is includes first information, second information, and third information. First information is information related to energy consumed when the mobile object is stopped while a driving source is in a state of operation. “When the mobile object is stopped while the driving source is in a state of operation” is a state where substantially no load is place on the engine of the mobile object and the engine operates at low speed. More specifically, “when the mobile object is stopped while the driving source is in a state of operation” is a state of idling.

For example, first information is energy consumption when the mobile object is parked with the engine is running, when the mobile object is stopped at a signal, etc. In other words, first information is the amount of energy consumed consequent to a factor unrelated to travelling by the mobile object. More specifically, the first information is energy consumption consequent to air conditioning and audio devices equipped on the mobile object.

Second information is information related to the energy consumed during acceleration of the mobile object. “During acceleration of the mobile object” is a traveling state where the speed of the mobile object changes temporally. More specifically, “during acceleration of the mobile object” is a travelling state where within a given period, the speed of the mobile object changes.

Third information is information related to the energy consumed by resistance occurring during travel by the mobile object. “During travel by the mobile object” is a travelling state where the speed of the mobile object is constant for a given period. “Resistance occurring during travel by the mobile object” is a factor that changes the travelling state of the mobile object during travel by the mobile object. For example, resistance occurring during travel by the mobile object” is resistance occurring with respect to the mobile object consequent to weather conditions, road conditions, vehicular conditions, etc.

Resistance consequent to weather conditions is air resistance resulting from, for example, weather changes such as rain and wind. Resistance consequent to road conditions is road surface resistance consequent to road gradients, road surfaces, etc. Resistance consequent to vehicular conditions is load resistance consequent to tire pressure, the number of passengers, and other imposed loads on the mobile object.

More specifically, the third information is energy consumption when the mobile object travels at a constant speed while subject to air resistance, road surface resistance, and imposed loads. For example, the third information is energy consumption when the mobile object travels at a constant speed while subject to air resistance consequent to headwind, road surface resistance from unpaved roads, etc.

The current-information acquiring unit 101 acquires the actual energy consumption and information related to the speed of the mobile object during travel. Information related to speed is, for example, speed and acceleration. Information related to speed may be the average speed or the average acceleration during a given period. A given period of time is, for example, a delimiter of a constant interval of time such as that for making a determination relative to per unit time.

The current-information acquiring unit 101 may acquire information related to the incline of the mobile object together with the actual energy consumption. Information related to the incline is, for example, the gradient of the road travelled by the mobile object, with respect to a road gradient of nearly zero. The current-information acquiring unit 101 may acquire, via CAN, speed, acceleration, and gradient related information managed by ECU.

The setting unit 102, for each factor causing energy consumption of the mobile object to change, sets information related to the mobile object having the factor. Information related to the mobile object is, for example, vehicle information, information related to vehicle information, etc. Vehicle information is, for example, the amount of emissions, weight, vehicle width, vehicle height, efficiency, air resistance, rolling resistance of the mobile object. Information related to vehicle information is, for example, information calculated based on one or more of the described types of vehicle information. The setting unit 102 may regard the mobile-object-related information provided by the manufacturer as initial information.

The estimating unit 103, based on mobile-object-related information for a reference point in time, estimates energy consumption consequent to travelling by the mobile object (hereinafter, “reference energy consumption”. For example, the estimating unit 103, based on the mobile-object-related information set by the setting unit 102, estimates reference energy consumption.

A reference point in time is information related to a past point in time used as a reference for acquiring the current state of the mobile object. The reference point in time may be information related to a period associated with the point in time that the current-information acquiring unit 101 acquired the actual energy consumption. Herein, time related information is the time, a date, a season, a period during which weather changes, a period of en event, etc.

For example, a reference point in time may be the point in time when the current-information acquiring unit 101 acquired the actual energy consumption, the same time during the previous day or year as the current time of travel of the mobile object, a day when the wind direction, speed, etc. was identical to the current conditions, the same period such as July 1 to August 31, 7 years ago in the case of a season (e.g., summer) identical to the period of the current travel by the mobile object, and an interval of several days during peak summer holiday traffic a few years ago in the case of the period of the current travel by the mobile object being during peak summer holiday traffic.

The estimating unit 103, in the case of multiple reference points in time, may calculate the average reference energy consumption based on information related to the multiple reference points in time, whereby, for example, an average reference energy consumption for similar reference points in time such as related to season, weather, etc. can be estimated.

More specifically, the estimating unit 103, based on the speed and acceleration acquired by the current-information acquiring unit 101, uses equation (1) representing an energy consumption estimating equation to calculate reference energy consumption for each factor causing the energy consumption of the mobile object to change.

$$\begin{matrix}\begin{matrix}fc ( x ) = {k}_{1} + {k}_{2} \cdot x \cdot ( \frac{d x}{d t} + g \cdot sin θ ) + {k}_{3} \cdot G ( x ) \\ G ( x ) = {x}^{3} + {a}_{1} \cdot {x}^{2} + {a}_{2} \cdot x\end{matrix} \} \\ & ( 1 ) \\ Where , & \\ fc ( x ) : consumed energy per unit time ( cc / sec ) \\ x : speed ( \frac{km}{h \cdot s} ) & \\ \frac{dx}{dt} : acceleration ( \frac{km}{h \cdot s} ) \\ g : speed of gravity ( = 35.3 ( \frac{km}{h \cdot s} ) ) \\ θ : gradient of road travelled by vehicle ( radian ) & \\ {k}_{1} : coefficient based on energy consumption while vehcile is \\ stopped with engine running ( \frac{cc}{s} ) \\ {k}_{2} : coefficient based on energy consumption \\ during acceleration ( \frac{cc \cdot {h}^{2}}{{km}^{2}} ) \\ & \\ {k}_{3} : coefficient based on air resistance and \\ rolling resistance ( \frac{cc \cdot {h}^{3}}{{km}^{3} \cdot s} ) \\ {a}_{1} , {a}_{2} : coefficient set according to vehicle state & \end{matrix}$$

In equation (1), the first term on the right corresponds to the first information, the second term on the right corresponds to the second information, and the third term on the right corresponds to the third information. Coefficients of each of the terms on the right, coefficient k₁, coefficient k₂, and coefficient k₃ (hereinafter, “coefficient kₙ”), correspond to information related to vehicle information. In other words, the estimating unit 103 uses the mobile-object-related information set by the setting unit 102 as equation (1).

In equation (1), although time is represented in units of hours (h) and seconds (s), (km/h) is adopted as a unit for speed, seconds (s) is adopted as the unit of time for estimating fuel consumption. Through suitable calculations, these units may be made consistent.

The estimating unit 103, may estimate the reference energy consumption based on mobile-object-related information recorded by the recording unit 105. In this case, the estimating unit 103 may use mobile-object-related information for a past point in time during the same period as the current travel period of the mobile object, as mobile-object-related information for a reference point in time. For example, the estimating unit 103 estimates the reference energy consumption based on a coefficient kₙ(n=1 to 3), speed, acceleration recorded by the recording unit 105 for a past given point in time.

The estimating unit 103, after the mobile object has been serviced, uses as mobile-object-related information for the reference point in time, mobile-object-related information for the point in time when the amount of change was calculated by the calculating unit 104. For example, the estimating unit 103 uses as the mobile-object-related information for the reference point in time, mobile-object-related information after tire replacement, an oil change, etc.

The estimating unit 103, based on the actual energy consumption, may estimate mobile-object-related information for each factor causing energy consumption of the mobile object to change. For example, the estimating unit 103, based on the actual energy consumption and speed related information acquired by the current-information acquiring unit 101, uses equation (1) representing an energy consumption estimating equation, and estimates by multi-regression analysis or regression analysis, coefficient kₙ that is based on the actual energy consumption.

The calculating unit 104 calculates for each factor causing energy consumption of the mobile object to change, the amount of change for the reference energy consumption of the actual energy consumption (hereinafter, “amount of change in actual energy consumption”). For example, the calculating unit 104, regarding the first information, the second information and the third information (hereinafter, “n-th information”) as factors causing energy consumption of the mobile object to change, calculates the amount of change of the actual energy consumption.

The calculating unit 104 may calculate the amount of change (hereinafter, “amount of change of coefficient kₙ”) of the coefficient kₙ(n=1 to 3) in the first to third terms on the right of equation (1), with respect to a past coefficient kₙ estimated at the reference point in time.

More specifically, for example, if the coefficient kₙ, which is based on the actual energy consumption, is estimated by the estimating unit 103, the calculating unit 104 uses as the coefficient kₙ of the reference point in time, the coefficient kₙ recorded at a past given point in time by the recording unit 105 and calculates the amount of change of the coefficient kₙ estimated by the estimating unit 103. Consequently, based on the coefficient kₙ (n=1 to 3), which is most closely associated with vehicle information, the amount of change, which is an index for identifying factors causing state changes of the mobile object, can be calculated.

A state change of the mobile object is, for example, a change in the tire state, air resistance, efficiency, vehicular weight, wind direction and speed, etc. Factors causing a change in the tire state include states changing the road surface resistance such as a flat tire, low air pressure, changes in the type of tread and tire size, etc. Factors causing changes in the air resistance of the mobile object include, for example, changes in the exterior shape of the mobile object consequent to the addition of auxiliary parts such as carriers. Factors causing changes in efficiency include, for example, operation of air conditioning and audio devices. Factors causing changes in vehicular weight include, for example, changes in items loaded on the mobile object and in the number of passengers.

The calculating unit 104 may calculate the amount of change in the weight of the mobile object. In this case, the calculating unit 104 uses as the vehicular weight for the reference point in time, the vehicular weight recorded for a past given point in time by the recording unit 105. Thus, in the case of a truck for which energy consumption varies greatly consequent to the loaded weight, whether the loaded weight of the mobile object is the cause of the change in the state of the mobile object can be determined.

The recording unit 105, when the calculating unit 104 calculates the amount of change for each factor, records mobile-object-related information that has been updated based on the amount of change. For example, the recording unit 105 records mobile-object-related information that has bee corrected based on the amount of change calculated by the calculating unit 104. The recording unit 105 records mobile-object-related information for the point in time when the calculating unit 104 calculated the amount of change after maintenance servicing of the mobile object. In other words, the recording unit 105 records information that is related to the mobile object and reflects the latest travelling state of the mobile object and the travelling state after maintenance servicing.

The recording unit 105 records mobile-object-related information and time related information for the point in time when the calculating unit 104 calculated the amount of change. For example, the recording unit 105 correlates mobile-object-related information with time related information for the point in time when the calculating unit 104 calculated the amount of change after maintenance servicing of the mobile object.

The recording unit 105, for example, may correct and record mobile-object-related information, based on information input by a user via an input unit (not depicted). Information input by the user, for example, indicates the presence/absence of accessories in the mobile object supplied with power from the battery of the mobile object, the addition of auxiliary parts to the exterior of the mobile object, etc.

The recording unit 105 may record the actual energy consumption and the speed related information acquired by the current-information acquiring unit 101 and the reference energy consumption and mobile-object-related information estimated by the estimating unit 103. For example, the recording unit 105 may record the n-th information (n=1 to 3), speed, and acceleration acquired by the current-information acquiring unit 101 and the n-th information and coefficient kₙ (n=1 to 3) estimated by the estimating unit 103.

The reporting unit 106, based on the amount of change calculated by the calculating unit 104, reports the current state of the mobile object with respect to the state of the mobile object at the reference point in time. For example, the reporting unit 106 reports the amount of change for the n-th information (or coefficient kₙ). Further, the reporting unit 106, based on the amount of change of the n-th information (or coefficient kₙ), reports a primary factor likely to cause the change in the state of the mobile object.

More specifically, for example, if the amount of change of the first information (or coefficient k₁) increased, the reporting unit 106 reports use of air conditioning and/or audio devices, engine trouble, etc. as a primary cause. Further, for example, if the amount of change of the second information (or coefficient k₂) increased, the reporting unit 106 reports an increase in vehicular weight consequent to an increase in the number of passengers, loaded weight, etc. as a primary cause. For example, if the amount of change of the third information (or coefficient k₃) increased, the reporting unit 106 reports low air pressure of the tires as a primary cause.

The reporting unit 106 may report a primary factor likely to cause the change in the state of the mobile object, based on the magnitude of the amount of change of the n-th information (or coefficient kₙ). For example, if the rate of increase of the amount of change of the first information (or coefficient k₁) is less than or equal to a preliminarily set threshold, the reporting unit 106 reports use of air conditioning and/or audio devices as a primary cause and if the rate of increase of the amount of change of the first information (or coefficient k₁) is greater than or equal to the preliminarily set threshold, reports engine trouble as a primary cause.

A mobile object information acquiring process by the mobile-object information acquiring apparatus 100 will be described. FIG. 2 is a flowchart of the mobile object information acquiring process by the mobile-object information acquiring apparatus. In the flowchart depicted in FIG. 2, the mobile-object information acquiring apparatus 100, via the current-information acquiring unit 101, acquires the actual energy consumption of the mobile object (step S201). The mobile-object information acquiring apparatus 100, via the setting unit 102, sets mobile-object-related information for each factor causing energy consumption of the mobile object to change (step S202). The mobile-object information acquiring apparatus 100, via the estimating unit 103, estimates reference energy consumption (step S203).

The mobile-object information acquiring apparatus 100, via the calculating unit 104, calculates respectively for the first information, the second information, and the third information (n-th information), the amount of change of actual energy consumption with respect to the reference energy consumption (hereinafter, “amount of change of the actual energy consumption”) (step S204). The mobile-object information acquiring apparatus 100, via the recording unit 105, records the amount of change respectively calculated for n-th information (step S205). The mobile-object information acquiring apparatus 100 reports the amount of change respectively calculated for the n-th information (step S206), and ends the processing according to the flowchart.

The mobile-object information acquiring apparatus 100 may provide or acquire as probe traffic information, the amount of change of the actual energy consumption. Further, the mobile-object information acquiring apparatus 100, at step S204, may calculate the amount of change of the coefficient kₙ. The mobile-object information acquiring apparatus 100, at step S206, may report the amount of change respectively calculated for the n-th information and mobile-object-related information for the point in time that the amount of change was calculated.

As described, the mobile-object information acquiring apparatus 100 according to the embodiment, calculates for each factor causing energy consumption of the mobile object to change, the amount of change of the actual energy consumption and acquires the state of the mobile object based on the amount of change. Thus, the mobile-object information acquiring apparatus 100 calculates an amount of change for each factor causing energy consumption of the mobile object to change and can therefore, determine for each factor causing the amount of change to change, whether the factor is a primary factor likely causing the state change of the mobile object, is a cause of travelling state changes, etc. For example, if the amount of change of the first information changes, the mobile-object information acquiring apparatus 100 can narrow down causes to report only trouble or failure that has a high potential of occurring during idling. The mobile-object information acquiring apparatus 100 reports the calculated amount of change and thus, enables the user to monitor state changes of the mobile object.

The mobile-object information acquiring apparatus 100 estimates reference energy consumption based on mobile-object-related information for a reference point in time and calculates the amount of change in actual energy consumption with respect to reference energy consumption. Consequently, the mobile-object information acquiring apparatus 100 can acquire state changes of the mobile object from a preferred past point in time as a reference point in time. For example, if the reference point in time is a day when no trouble occurred in the mobile object and travel conditions were similar to the current travelling conditions, the mobile-object information acquiring apparatus 100 can determine that no trouble or failure is occurring in the mobile object based on the past amount of change of actual energy consumption being nearly zero.

The mobile-object information acquiring apparatus 100 estimates coefficient kₙ, which is based on the actual energy consumption, and consequent to the amount of change of coefficient kₙ (n=1 to 3) varying, reports a state change of the mobile object. Thus, the mobile-object information acquiring apparatus 100 can determine the cause of a state change of the mobile object, based on coefficient kₙ associated with information most related to vehicle information.

The mobile-object information acquiring apparatus 100 reports the amount of change in the weight of the mobile object. Consequently, for example, if energy consumption changes greatly consequent to the loaded weight, as with a truck, the mobile-object information acquiring apparatus 100 can clearly determine whether the cause of the state change of the mobile object is the loaded weight of the mobile object.

The mobile-object information acquiring apparatus 100 acquires the amount of change of the actual energy consumption as probe information and if, for example, at a point of travel of the mobile object, multiple travel resistances of the mobile object change in a constant direction overall, the mobile-object information acquiring apparatus 100 can determine that the mobile object is being affected by wind.

### Example

An example of the present invention will be described. In the present example, a navigation apparatus 300 equipped on a vehicle will be described as one example of application of the mobile-object information acquiring apparatus 100.

### Hardware Configuration of Navigation Apparatus 300

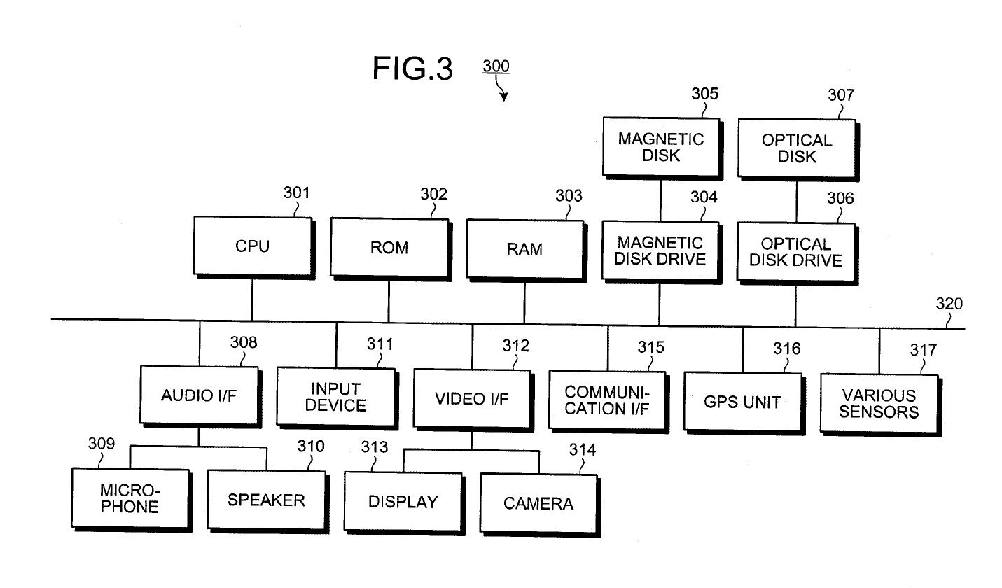

A hardware configuration of the navigation apparatus 300 will be described. FIG. 3 is a block diagram of a hardware configuration of the navigation apparatus. In FIG. 3, the navigation apparatus 300 includes a CPU 301, a ROM 302, a RAM 303, a magnetic disk drive 304, a magnetic disk 305, an optical disk drive 306, an optical disk 307, an audio interface (I/F) 308, a microphone 309, a speaker 310, an input device 311, a video I/F 312, a display 313, a camera 314, a communication I/F 315, a GPS unit 316, and various sensors 317, respectively connected by a bus 320.

The CPU 301 governs overall control of the navigation apparatus 300. The ROM 302 stores programs such as a boot program and a data updating program. The RAM 303 is used as a work area of the CPU 301. In other words, the CPU 301 uses the RAM 303 as a work area and executes various programs stored in the ROM 302 and thereby, governs overall control of the navigation apparatus 300.

The magnetic disk drive 304, under the control of the CPU 301, controls reading and writing with respect to the magnetic disk 305. The magnetic disk 305 stores data written thereto under the control of the magnetic disk drive 304. A hard disk (HD) or a flexible disk (FD) may be used as the magnetic disk 305.

The optical disk drive 306, under the control of the CPU 301, controls reading and writing with respect to the optical disk 307. The optical disk 307 is a removable recording medium from which data is read out under the control of the optical disk drive 306. A writable recording medium can be used as the optical disk 307. Aside from the optical disk 307, an MO, memory, etc. can be used as the removable recording medium.

An example of information recorded to the magnetic disk 305 and the optical disk 307 includes map data and vehicle related information, information related to vehicle speed, energy consumption (actual energy consumption) accompanying vehicle travel, energy consumption (reference energy consumption) consequent to vehicle travel and based on vehicle related information for a reference point in time, and coefficient kₙ that is based on the actual energy consumption. Map data is used when in a car navigation system, the vehicle state acquired by a vehicle information acquiring process is reported and includes background data that describes terrestrial objects (features) such as buildings, rivers, land surfaces, etc., and road-shape data that represents the shapes of road by links and nodes.

The audio I/F 308 is connected to the microphone 309 for the input of sound and the speaker 310 for the output of sound. Sound received by the microphone 309 is A/D converted by the audio I/F 308. The microphone 309, for example, is disposed on the dashboard of the vehicle, the number of which may he plural. The speaker 310 outputs sound D/A converted from a given audio signal by the audio I/F 308.

The input device 311 may be, for example, a remote controller, a keyboard, or a touch panel having keys used to input characters, numerical values, or various kinds of instructions. Further, the input device 311 may be implemented by any one, or more, of the remote controller, the keyboard, and the touch panel.

The video I/F 312 is connected to the display 313. The video I/F 312 is made up of, for example, a graphic controller that controls the display 313, a buffer memory such as VRAM (Video RAM) that temporarily stores immediately displayable image information, and a control IC that controls the display 313 based on image data output from the graphic controller.

The display 313 displays icons, a cursor, menus, windows, or various data such as text and images. A TFT liquid crystal display, an organic EL display and the like may be employed as the display 313.

The camera 314 records images inside or outside the vehicle. The images may be still images or moving pictures. For example, images outside the vehicle are recorded by the camera 314 and the recorded images are subjected to image analysis at the CPU 301, are output via the video I/F 312 to a recording medium such as the magnetic disk 305 and the optical disk 307, etc.

The communication I/F 315 is wirelessly connected to a network and functions as an interface of the navigation apparatus 300 and the CPU 301. Communication networks functioning as the network include public line networks, mobile telephone networks, dedicated short range communication (DSRC), LANs, and WANs. The communication I/F 315 is, for example, a module for connecting to a public line, a non-stop, automatic toll payment system (ETC) unit, an FM tuner, a Vehicle Information and Communication System (VICS)/beacon receiver, etc.

The GPS unit 316 receives signals from GPS satellites and outputs information indicating the position of the vehicle. The information output by the GPS unit 315 is used together with values output from various sensors, described hereinafter, in the calculation of the current position of the vehicle, by the CPU 301. Information indicative of current position includes, for example, information indicating one point on map information, such as latitude, longitude, altitude, etc.

The various sensors 317 include a vehicular speed sensor, an acceleration sensor, and an angular speed sensor that respectively output information used to determine the position and behavior of the vehicle. Values output from the various sensors 316 are used by the CPU 301 to compute the current position and measure changes in speed, direction, etc.

Functions of the current-information acquiring unit 101, the setting unit 102, the estimating unit 103, the calculating unit 104, the recording unit 105, and the reporting unit 106 of the mobile-object information acquiring apparatus 100 depicted in FIG. 1 are implemented by an execution of a program on the CPU 301, using programs and data stored on the ROM 302, the RAM 303, the magnetic disk 305, the optical disk 307 of the navigation apparatus 300 and controlling units in the navigation apparatus 300.

### Overview of Energy Estimation by Navigation Apparatus 300

The navigation apparatus 300 of the present example estimates the energy consumed per unit time during travel of the vehicle equipped with the navigation apparatus 300. The navigation apparatus 300, based on the estimated energy consumption, estimates the amount of energy conserved. Further, the navigation apparatus 300, for example, based on the actual energy consumption, speed, and acceleration acquired via CAN, estimates vehicle information by multi-regression analysis and regression analysis.

For example, the navigation apparatus 300 uses equation (1) to estimate energy consumption of the vehicle.

$$\begin{matrix}\begin{matrix}fc ( x ) = {k}_{1} + {k}_{2} \cdot x \cdot ( \frac{d x}{d t} + g \cdot sin θ ) + {k}_{3} \cdot G ( x ) \\ G ( x ) = {x}^{3} + {a}_{1} \cdot {x}^{2} + {a}_{2} \cdot x\end{matrix} \} \\ & ( 1 ) \\ Where , \\ f c ( x ) : consumed energy per unit time ( cc / sec ) \\ x : speed ( \frac{km}{h} ) \\ & \\ \frac{dx}{dt} : acceleration ( \frac{km}{h \cdot s} ) \\ g : speed of gravity ( = 35.3 ( \frac{km}{h \cdot s} ) ) \\ θ : gradient of road travelled by vehicle ( radian ) \\ & \\ {k}_{1} : coefficient based on energy consumption while vehcile is \\ stopped with engine running ( \frac{cc}{s} ) \\ {k}_{2} : coefficient based on energy consumption \\ during acceleration ( \frac{cc \cdot {h}^{2}}{{km}^{2}} ) \\ & \\ {k}_{3} : coefficient based on air resistance and \\ rolling resistance ( \frac{cc \cdot {h}^{3}}{{km}^{3} \cdot s} ) \\ {a}_{1} , {a}_{2} : coefficient set according to vehicle state & \end{matrix}$$

In equation (1), the first term on the right corresponds to energy consumption during idling (first information), the second term on the right corresponds to energy consumption during speed variations (second information), and the third term on the right corresponds to energy consumption during travel at a constant speed (third information). Coefficients of each of the terms on the right, coefficient k₁, coefficient k₂, and coefficient k₃ (coefficient kₙ), are vehicle information.

In equation (1), although time is represented in units of hours (h) and seconds (s), (km/h) is adopted as a unit for speed, seconds (s) is adopted as the unit of time for estimating fuel consumption. Through suitable calculations, these units may be made consistent.

### Mobile Object Information Acquiring Process of Navigation Apparatus 300

As described, the navigation apparatus 300, for each factor causing energy consumption of the vehicle to change, calculates the amount of change of the actual energy consumption with respect to reference energy consumption and consequent to the amount of change varying, acquires and reports the state of the mobile object from a reference point in time. Details of the mobile object information acquiring process will be described.

### Mobile Object Information Acquiring Process: Part 1

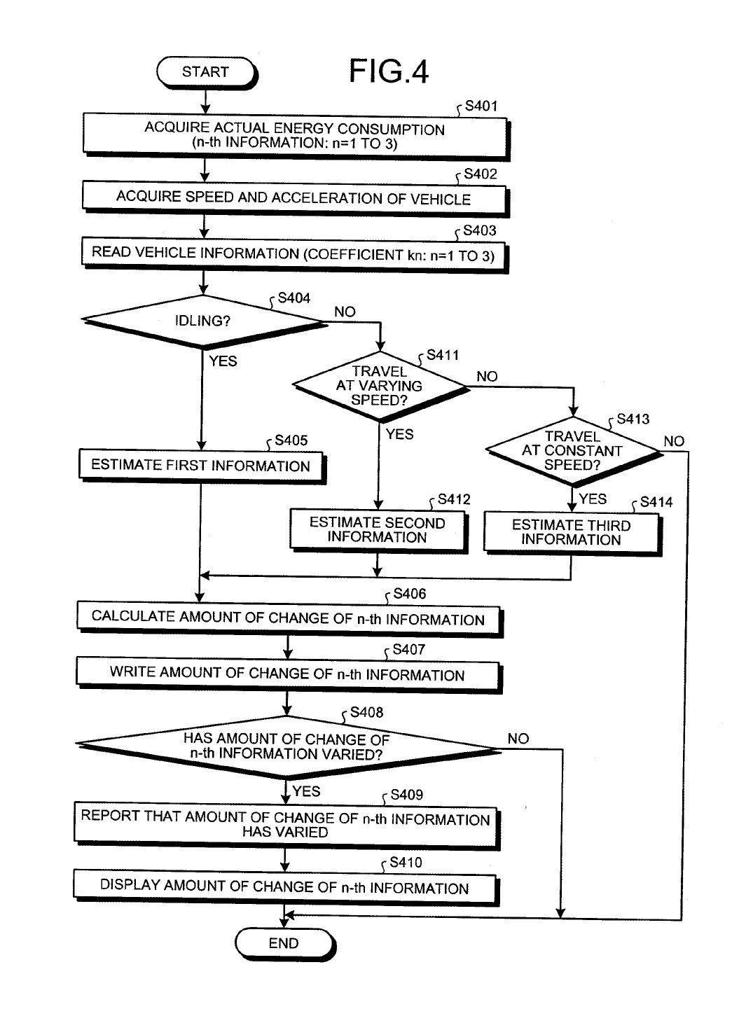

FIG. 4 is a flowchart of the mobile object information acquiring process by the navigation apparatus. In the flowchart depicted in FIG. 4, the navigation apparatus 300 acquires via CAN, the actual energy consumption (n-th information: n=1 to 3) managed by ECU (step S401). For example, the navigation apparatus 300 respectively acquires the actual energy consumption for idling, travel at varying speed, and travel at constant speed described hereinafter and can thereby properly acquire the n-th information: n=1 to 3. The navigation apparatus 300, for example, acquires the speed and acceleration of the vehicle by the various sensors 317 (step S402). The navigation apparatus 300 reads vehicle information (coefficient kₙ: n=1 to 3) stored in a storage apparatus (magnetic disk 305, optical disk 307) (step S403).

The navigation apparatus 300 determines whether the vehicle is idling (step S404). If the vehicle is idling (step S404: YES), the navigation apparatus 300 uses the energy consumption estimating equation expressed by equation (1) and estimates reference energy consumption (step S405). The reference energy consumption estimated at step S405 is the concerning consumption during idling.

The navigation apparatus 300 calculates the amount of change of the actual energy consumption acquired at step S401 with respect to the reference energy consumption estimated at step S405 (amount of change of actual energy consumption) (step S406). At step S404: YES, since the vehicle is determined to be idling, in this case, the actual energy consumption acquired at step S401 is the first information and the amount of change calculated at step S406 is the amount of change of the first information.

The navigation apparatus 300 writes to the storage apparatus, the amount of change of the n-th information calculated at step S406 (step S407). The navigation apparatus 300 determines whether of the amount of change of the n-th information has varied (step S407). For example, the navigation apparatus 300 may determine that the amount of change has varied if the amount of change of the n-th information is not zero, or if the amount of change of the n-th information is greater than or equal to a preliminarily set threshold.

If the amount of change of the n-th information has varied (step S408: YES), the navigation apparatus 300, for example, via the audio I/F 308 and using the speaker 310, reports that the amount of change of the n-th information has varied (step S409). For example, the navigation apparatus 300 displays on the display 313, the amount of change of the n-th information (step S410), and ends the processing according to the flowchart. If the amount of change of the n-th information has not varied (step S408: NO), the navigation apparatus 300 ends the processing according to the flowchart.

If the vehicle is not idling (step S404: NO), the navigation apparatus 300 determines whether the vehicle is travelling at varying speed (step S411). If the vehicle is travelling at varying speed (step S411: YES), the navigation apparatus 300, similar to the operation at step S405, estimates reference energy consumption (step S412), and proceeds to step S406. The reference energy consumption estimated at step S412 is the second information concerning consumption during speed variation. Also, in this case, the actual energy consumption acquired at step S401 is the second information concerning consumption during speed variation. The navigation apparatus 300 performs the operations at step S406 to step S410 as described above, and ends the processing according to the flowchart.

If the vehicle is not travelling at varying speed (step S411: NO), the navigation apparatus 300 determines whether the vehicle is travelling at constant speed (step S413). If the vehicle is travelling at constant speed (step S413: YES), the navigation apparatus 300, similar to the operation at step S405, estimates reference energy consumption (step S414), and proceeds to step S406. The reference energy consumption estimated at step S414 is the third information concerning consumption during travel at a constant speed. Also in this case, the actual energy consumption acquired at step S401 is the third information. The navigation apparatus 300 performs the operations at step S406 to step S410 as described above, and ends the processing according to the flowchart.

If the vehicle is not travelling at a constant speed (step S413: NO), the navigation apparatus 300 ends the processing according to the flowchart, without performing the operations at step S406 to step S410.

At step S410, the navigation apparatus 300 may display the amount of change of the n-th information and information related to the vehicle state based on the amount of change of the n-th information. “Information related to the vehicle state based on the amount of change of the n-th information” is a warning or instruction for the user such as “travel resistance is increasing”, “check tire pressure”, etc. The navigation apparatus 300 may give a warning or instruction from the speaker 310, using the audio I/F 308.

The navigation apparatus 300 recursively performs the mobile object information acquiring process while the engine of the vehicle is in a state of operation. In other words, after the engine enters a state of operation, the navigation apparatus 300 calculates the amount of change of the first information until the vehicle start moving and if the amount of change of the first information has varied, the navigation apparatus 300 reports the amount of change of the first information. During travel from a departure point to a destination point, the navigation apparatus 300 respectively calculates the amount of change of the n-th information for a point in time during idling (e.g., while waiting for a signal), speed variation, and constant speed; and if the amount of change of the n-th information has varied, the navigation apparatus 300 reports the amount of change of the n-th information.

At steps S405, S412, and S414, the navigation apparatus 300 may calculate the amount of change of the n-th information, using as reference energy consumption for a reference point in time, reference energy consumption read from among past reference energy consumption values (n-th information) stored in the storage apparatus and estimated for previous travel. The reference point in time may be information related to a period associated with the point in time when the actual energy consumption was acquired at step S401.

### Mobile Object Information Acquiring Process: Part 2

Another example of the mobile object information acquiring process by the navigation apparatus 300 will be described. The navigation apparatus 300 estimates coefficient kₙ (n=1 to 3) of equation (1) and if the amount of change of coefficient kₙ (amount of change of coefficient kₙ) has varied with respect to coefficient kₙ for a past given point in time, the navigation apparatus 300 may report the amount of change of coefficient kₙ. Here, coefficient kₙ is a coefficient based on the actual energy consumption.

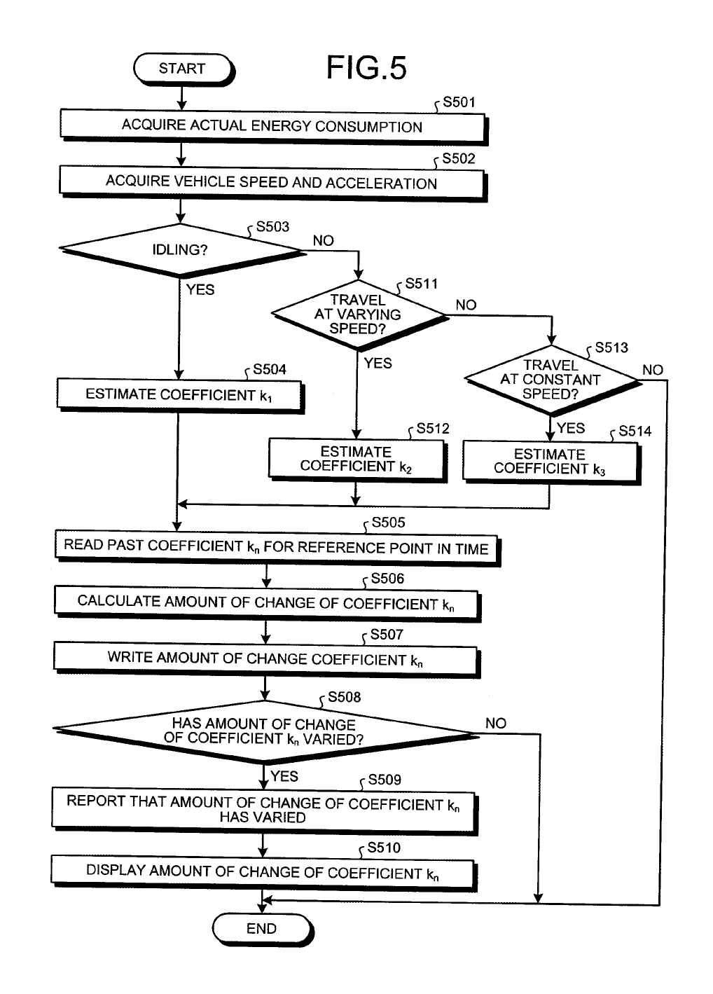

FIG. 5 is a flowchart the mobile object information acquiring process of by the navigation apparatus. In the flowchart depicted in FIG. 5, the navigation apparatus 300, via CAN, acquires the actual energy consumption managed by ECU (step S501). The navigation apparatus 300, for example, acquires, by the various sensors 317, the vehicle speed and acceleration (step S502).

The navigation apparatus 300 determines whether the vehicle is idling (step S503). If the vehicle is idling (step S503: YES), the navigation apparatus 300, based on the actual energy consumption, speed, and acceleration acquired at steps S501 and S502, uses equation (1) representing an energy consumption estimating equation and estimates coefficient k₁ by multi-regression analysis or regression analysis (step S504). The coefficient k₁ estimated at step S504 is a coefficient based on energy consumption concerning idling.

The navigation apparatus 300, for example, reads from among past coefficients kₙ estimated for previous travel and stored in a storage apparatus, a past coefficient kₙ for a reference point in time (step S505). At step S503: YES, since the vehicle has been determined to be idling, the navigation apparatus 300 reads out a past coefficient k₁.

The navigation apparatus 300 calculates with respect to coefficient kₙ read out at step S505, the amount of change (amount of change of coefficient kₙ) of the coefficient kₙ estimated at step S504 (step S506). In this case, the amount of change of coefficient k₁ is calculated. The navigation apparatus 300 writes to the storage apparatus, the amount of change coefficient kₙ calculated at step S506 (step S507). Here, the navigation apparatus 300 may write the amount of change of coefficient kₙ and coefficient kₙ. The navigation apparatus 300 determines whether the amount of change of coefficient kₙ has varied (step S508).

If the amount of change of coefficient kₙ has varied (step S508: YES), the navigation apparatus 300, for example, via the audio I/F 308 and using the speaker 310, reports that the amount of change of coefficient kₙ has varied (step S509). The navigation apparatus 300, for example, displays on the display 313, the amount of change of coefficient kₙ (step S510), and ends the processing according to the flowchart. If the amount of change of coefficient kₙ has not varied (step S508: NO) the navigation apparatus 300 ends the processing according to the flowchart.

If the vehicle is not idling (step S503: NO), the navigation apparatus 300 determines whether the vehicle is travelling at varying speed (step S511). If the vehicle is travelling at varying speed (step S511: YES), the navigation apparatus 300, similar to the operation at step S504, estimates coefficient k₂ (step S512), and proceeds to step S505. The coefficient k₂ estimated at step S512 is a coefficient based on energy consumption concerning consumption during speed variation. The navigation apparatus 300 performs the operations at steps S505 to S510, as described above, and ends the processing according to the flowchart.

If the vehicle is not traveling at varying speed (step S511: NO), the navigation apparatus 300 determines whether the vehicle is travelling at constant speed (step S513). If the vehicle is travelling at constant speed (step S513: YES), the navigation apparatus 300, similar to the operation at step S504, estimates coefficient k₃ (step S514), and proceeds to step S505. The coefficient k₃ estimated at step S514 is a coefficient based on energy consumption during travel at a constant speed. The navigation apparatus 300 performs the operations at steps S505 to S510 as described above, and ends the processing according to the flowchart.

If the vehicle is not travelling at a constant speed (step S513: NO), the navigation apparatus 300 ends the processing according to the flowchart, without performing the operations at steps S505 to S510.

In the mobile object information acquiring process depicted in FIG. 5, similar to the mobile object information acquiring process depicted in FIG. 4, the navigation apparatus 300 recursively performs the mobile object information acquiring process while the engine of the vehicle is in a state of operation. Further, the same criterion used in the mobile object information acquiring process depicted in FIG. 4 may be used as a criterion for determining whether the amount of change of coefficient kₙ has varied. At step S510, for example, similar to the mobile object information acquiring process depicted in FIG. 4, the information displayed on the display 313 may be the n-th information and the amount of change of the n-th information (refer to step S410), or may be coefficient kₙ and the amount of change of coefficient kₙ instead of the n-th information.

In the mobile object information acquiring process depicted in FIG. 5, although coefficient k, which is estimated according to the travel state of the vehicle, is selected, all of the coefficients k₁ to k₃ may be estimated irrespective of the travel state. In this case, the navigation apparatus 300, after step S502, based on the actual energy consumption, speed, and acceleration acquired at steps S501 and S502, uses equation (1) representing an energy consumption estimating equation to calculate coefficients k₁ to k₃ by multi-regression analysis or regression analysis (step S503′). Subsequently, the navigation apparatus 300 transitions to the reading of a past coefficient at step S505. Thus, estimation of coefficients, which is complicated, can be performed for all coefficients k₁ to k₃, irrespective of the travel state of the vehicle.

### Mobile Object Information Acquiring Process: Part 3

The navigation apparatus 300 estimates vehicular weight as concrete information indicated by coefficient kₙ and if the amount of change of the estimated vehicular weight (hereinafter, “amount of change of the vehicular weight”) has varied with respect to the vehicular weight for a past given point in time, the navigation apparatus 300 may report the amount of change of the vehicular weight.

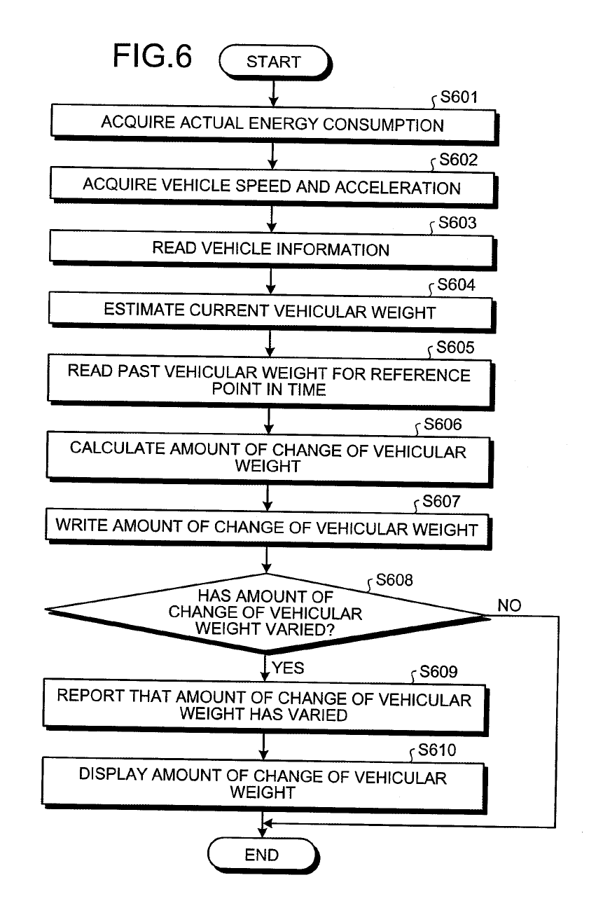

FIG. 6 is a flowchart of yet another mobile object information acquiring process by the navigation apparatus. In the flowchart depicted in FIG. 6, the navigation apparatus 300, via CAN, acquires the actual energy consumption managed by ECU (step S601). The navigation apparatus 300, for example, acquires, by the various sensors 317, the vehicle speed and acceleration (step S602).

The navigation apparatus 300 reads vehicle information stored in a storage apparatus (magnetic disk 305, optical disk 307) (step S603). The navigation apparatus 300 uses equation (1) representing an energy consumption estimating equation to estimate the current vehicular weight by multi-regression analysis or regression analysis (step S604). For example, vehicular weight can be estimated by estimating coefficient k₂. The navigation apparatus 300 reads from among past vehicular weights estimated for previous travel and stored in the storage apparatus, a past vehicular weight for a reference point in time (step S605).

The navigation apparatus 300 calculates the amount of change of the vehicular weight estimated at step S604 (amount of change of the vehicular weight) with respect to the vehicular weight read out at step S605 (step S606). The navigation apparatus 300 writes to the storage apparatus, the amount of change of the vehicular weight calculated at step S606 (step S607). The navigation apparatus 300 determines whether the amount of change of the vehicular weight has varied (step S608).

If the amount of change of the vehicular weight has varied (step S608: YES), the navigation apparatus 300, for example, via the audio I/F 308 and using the speaker 310, reports that the amount of change of the vehicular weight has varied (step S609). The navigation apparatus 300, for example, displays on the display 313, the actual energy consumption, the amount of change of the vehicular weight, and a warning or instruction concerning the amount of change of the vehicular weight (step S610), and ends the processing according to the flowchart. If the amount of change of the vehicular weight has not varied (step S608: NO), the navigation apparatus 300 ends the processing according to the flowchart.

In the mobile object information acquiring process depicted in FIG. 6, similar to the mobile object information acquiring process depicted in FIG. 4, the navigation apparatus 300 recursively performs the mobile object information acquiring process while the engine of the vehicle is in a state of operation. Further, the same criterion used in the mobile object information acquiring process depicted in FIG. 4 may be used as the criterion for determining whether the amount of change of the vehicular weight has varied.

According to the mobile object information acquiring process depicted in FIG. 6, the navigation apparatus 300 warns or instructs the user based on the amount of change of the vehicular weight and thus, for example, if the present process is applied to a vehicle for which energy consumption differs greatly consequent to the loaded weight, such as for a truck, determination can be made whether the increase in energy consumption is caused by the loaded weight or the driving technique of the driver. The navigation apparatus 300 records the amount of change of the vehicular weight and the actual energy consumption and thus, by comparing this information and reference energy consumption, can convert the amount of energy conserved by the driver into, for example, a monetary value, thereby enabling monetary savings to be known.

### Amount of Change Display Example

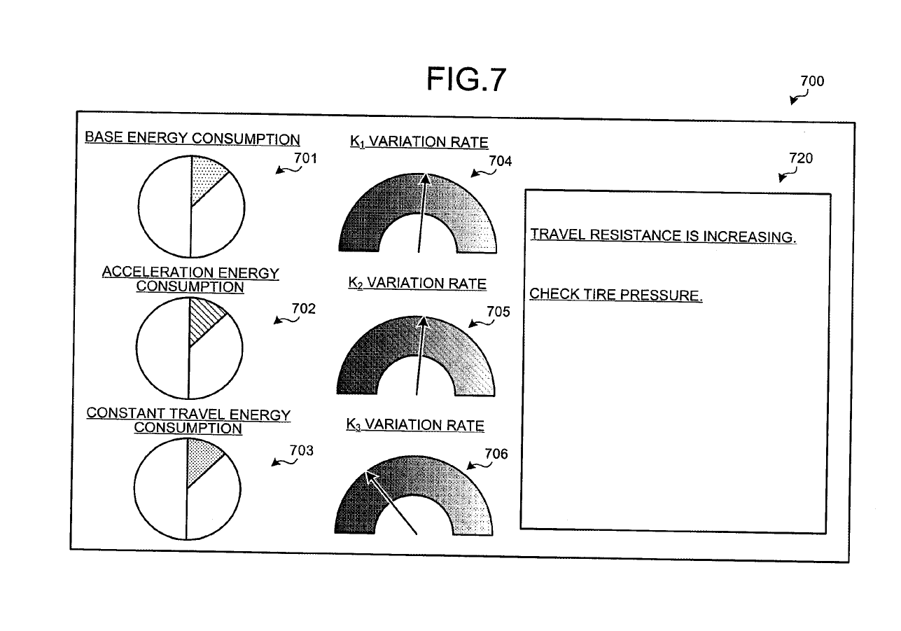

Information displayed in the display by the mobile object information acquiring process will be described. FIG. 7 is a diagram of one example of a display screen displayed on the display of the navigation apparatus. As depicted in FIG. 7, for example, a display 700 includes a first meter 701 displaying energy consumption during idling of the vehicle (base energy consumption), a second meter 702 displaying energy consumption consequent to travel at varying speed (acceleration energy consumption), a third meter 703 displaying energy consumption consequent to travel at a constant speed (constant travel energy consumption), a fourth meter 704 displaying the amount of change of the first information (k₁ variation rate), a fifth meter 705 displaying the amount of change of the second information (k₂ variation rate), a sixth meter 706 displaying the amount of change of the third information (k₃ variation rate), and a message window 720 displaying warnings, instructions, etc. to the user. These display items are one example of a layout displayed on the display of the n-th information (n=1 to 3), the amount of change, etc. In other words, depicted example represents a state after the operation at step S410 in FIG. 4.

For example, if the amount of change of the n-th information has varied, the navigation apparatus 300 displays the meters 701 to 706 and the message window 720 on the display 700. The navigation apparatus 300 may continuously display the meters 701 to 706 and the message window 720 together with map data on the display 700, in which case a “close” button (not depicted) may be displayed on the display 700, whereby the user can terminate the display of the meters, etc.

The navigation apparatus 300 may be configured to display the meters 701 to 706 and the message window 720 on the display 700 only when the vehicle has stopped such as while waiting for a signal. In this case, the navigation apparatus 300 correlates with the amount of change of the n-th information, a flag indicating that the amount of changes has not been displayed on the display 700 and when the vehicles stops, collectively displays on the display 700, each amount of change for which the flag is set.

Thus, according to the navigation apparatus 300, for each factor causing energy consumption of the vehicle to change, the amount of change of the actual energy consumption is calculated and a vehicle state based on the amount of change is acquired. In this manner, the navigation apparatus 300 calculates for each factor causing energy consumption of the vehicle to change, the amount of change and can therefore, determine for each factor causing the amount of change to change, whether the factor is a primary factor likely causing the state change of the mobile object, is a cause of travelling state changes, etc.

The navigation apparatus 300 estimates reference energy consumption based on information related to the vehicle for a reference point in time and calculates the amount of change of the actual energy consumption with respect to the reference energy consumption. Consequently, the navigation apparatus 300 can acquire state changes of the vehicle from a preferred past point in time as a reference point in time.

The navigation apparatus 300 estimates coefficient kₙ, which is based on the actual energy consumption, and consequent to the amount of change of coefficient kₙ (n=1 to 3) varying, reports a state change of the vehicle. Thus, the navigation apparatus 300 can determine the cause of a state change of the mobile object, based on coefficient kₙ associated with information most related to vehicle information.

The navigation apparatus 300 reports the amount of change in the weight of the vehicle. Consequently, for example, if energy consumption changes greatly consequent to the loaded weight, as with a truck, the navigation apparatus 300 can clearly determine whether the cause of the state change of the mobile object is the loaded weight of the mobile object.

The navigation apparatus 300 [symbol] actual energy consumption acquires the amount of change of the actual energy consumption as probe information and if, for example, at a point of travel of the vehicle, multiple travel resistances of the vehicle change in a constant direction overall, the navigation apparatus 300 can determine that the mobile object is being affected by wind.

The mobile-object information acquiring method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

### EXPLANATIONS OF LETTERS OR NUMERALS

100 mobile-object information acquiring apparatus
101 current-information acquiring unit
102 setting unit
103 estimating unit
104 calculating unit
105 recording unit
106 reporting unit

1-11. (canceled)

12. A mobile-object information acquiring apparatus comprising:
a current-information acquiring unit that acquires energy consumption (hereinafter, “actual energy consumption”) accompanying travel of a mobile object;
a setting unit that sets for each factor of a plurality of factors causing energy consumption of the mobile object to change, information related to the mobile object having the factor;
an estimating unit that based on the information related to the mobile object for a reference point in time and set by the setting unit, estimates energy consumption consequent to travel (hereinafter, “reference energy consumption”); and
a calculating unit that for each of the factors, calculates an amount of change of the actual energy consumption with respect to the reference energy consumption.

13. The mobile-object information acquiring apparatus according to claim 12, wherein
the calculating unit regards as the factors causing the energy consumption of the mobile object to change, first information related to energy consumed during idling of the mobile object in a state where a driving source is in operation, second information related to energy consumed during speed variation of the mobile object, and third information related to energy consumed consequent to resistance occurring during travel of the mobile object, and calculates the amount of change.

14. The mobile-object information acquiring apparatus according to claim 12, wherein
the current-information acquiring unit acquires together with the actual energy consumption, information related to speed during travel of the mobile object,
the estimating unit, based on the speed acquired by the current-information acquiring unit, uses an energy consumption estimating equation, and estimates the reference energy consumption.

15. The mobile-object information acquiring apparatus according claim 12, further comprising
a recording unit that when the amount of change is calculated by the calculating unit, records the information related to the mobile object, updated based on the amount of change, wherein
the estimating unit estimates the reference energy consumption, based on the information related to the mobile object and recorded by the recording unit.

16. The mobile-object information acquiring apparatus according to claim 15, wherein
the recording unit records together with the information related to the mobile-object-related information, information related to a period associated with a point in time when the calculating unit calculated the amount of change, and
the estimating unit uses the information that is related to the mobile object and for a past given point in time during a period identical to the period of the current travel of the mobile object, as the information that is related to the mobile object and for the reference point in time.

17. The mobile-object information acquiring apparatus according to claim 15, wherein
the recording unit records the information that is related to the mobile object and for a point in time when the amount of change was calculated by the calculating unit, after maintenance servicing of the mobile object, and
the estimating unit uses the information that is related to the mobile object and for the point in time when the amount of change was calculated, as the information that is related to the mobile object and for the reference point in time.

18. The mobile-object information acquiring apparatus according claim 12, further comprising
a reporting unit that based on the amount of change calculated by the calculating unit, reports the current state of the mobile object with respect to the state of the mobile object at the reference point in time.

19. A mobile-object information acquiring apparatus comprising:
a current-information acquiring unit that acquires energy consumption (hereinafter, “actual energy consumption”) accompanying travel of a mobile object;
an estimating unit that based on the actual energy consumption and for each factor causing energy consumption of the mobile object to change, respectively estimates information related to the mobile object affected by the factor;
a recording unit that records the information that is related to the mobile object and estimated by the estimating unit; and
a calculating unit that calculates for each factor and with respect to information that is related to the mobile object and recorded by the recording unit at a past given point in time, an amount of change of the information that that is related to the mobile object and estimated by the estimating unit.

20. A mobile-object information acquiring method of a mobile-object information acquiring apparatus that acquires information of a mobile object, the method comprising:
acquiring actual energy consumption accompanying travel of the mobile object;
separating the actual energy consumption according to factors causing energy consumption of the mobile object to change and estimating actual energy consumption caused by each factor;
acquiring for each factor, reference energy consumption accompanying the travel of the mobile object at a reference point in time; and
calculating for each factor, an amount of change of the actual energy consumption with respect to the reference energy consumption.

21. A computer-readable recording medium storing a mobile-object information acquiring program causing a computer to execute the mobile-object information acquiring method according to claim 20.
